(19) United States
(12) Patent Application Publication
(10) Pub. No.: US 2015/0294414 A1
(43) Pub. Date: Oct. 15, 2015

(54) RISK LADDER

(71) Applicant: Trading Technologies International, Inc., Chicago, IL (US)

(72) Inventors: Michael J. Burns, Riverside, IL (US); Scott F. Singer, Green Oaks, IL (US)

(73) Assignee: Trading Technologies International, Inc., Chicago, IL (US)

(21) Appl. No.: 14/251,996

(22) Filed: Apr. 14, 2014

(51) Int. Cl. G06Q 40/04

(52) U.S. Cl. CPC G06Q 40/04

(57) ABSTRACT

Certain embodiments provide systems and methods to calculate and display a normalized risk for one or more traders. An example method includes converting a profit and loss amount associated with a first trader to a first trader unit value, the first trader unit value associated with an increment. The example method includes normalizing the first trader unit value based on a risk scale to provide a first normalized unit value for the trader. The example method includes displaying the first normalized unit value for the trader in a ranking of one or more traders based on the normalized unit value for each trader. The example method includes comparing the first normalized unit value to a risk criterion. The example method includes enabling or impeding a trade action by the trader based on the comparing of the normalized unit value to the risk criterion.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

Electronic exchanges have made it possible for an increasing number of participants to be active in a market at any given time. The increase in the number of potential market participants has led to, among other things, a more competitive market and greater liquidity. In the competitive environment of electronic trading, where every second or a fraction of second counts in intercepting trading opportunities, trading algorithms are beneficial to automate electronic trading.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 depicts an example trading system including a risk administrator device in communication with a trading device, gateway, and exchange.

FIG. 5 illustrates a flow diagram of an example method to quantify and visualize relative risk of one or more traders.

FIGS. 6A-6B illustrate example graphical user interfaces including a risk ladder showing a plurality of traders ranked on the ladder according to relative scaled or normalized risk.

FIG. 7 illustrates a block diagram representative of an example risk calculation system providing risk evaluation, monitoring, and display in a trading system.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Exchanges facilitate transactions between users of a marketplace wanting to, for example, buy or sell one or more tradeable objects. An order submitted to an exchange is, for example, a buy order or a sell order for a given tradeable object. The exchange attempts to match received orders with contra-side orders available in a corresponding market. For example, to fulfill a received buy order for a tradeable object, the exchange analyzes availability of the tradeable object on a market. Similarly, to fulfill a received sell order for the tradeable object, the exchange analyzes demand for the tradeable object on the market. The exchange can evaluate a level of risk or risk tolerance associated with the order and/or the trader placing the order, for example. The exchange then processes the order in accordance with the current conditions of the market. To process the trade orders, the exchange executes and/or facilitates a plurality of calculations, transactions, and communications.

In general, a market participant desires to be able to react more quickly than other market participants. For example, a market participant (or trader or other user) generally desires to be “first-to-market” (e.g., have trade orders entered prior to other market participants entering the same or similar orders). It is therefore desirable to improve the way market data is displayed to the market participant and to allow the market participant to make fast and accurate order entry. The slightest speed advantage may give a market participant a significant competitive advantage.

Trading applications allow market participants to initiate trade actions via a trading device. In some examples, a trading application may present a user interface including a trading window(s) or trading screen(s) to display market data or a portion of the market data. In addition, the trading window may include a trade action control to initiate or execute a trade action. A trade action control is a button, a cell, or an area on a trading window that corresponds to a particular trade action. In some examples, when a trade action control is selected or otherwise enabled, the trading device may execute or perform the corresponding trade action, such as placing, cancelling or changing a trade order.

Touch screens allow a market participant to directly or indirectly interact with a trading application. In some examples, the market participant performs (or executes) the trading application by directly interacting with the components displayed in a trading window via the touch screen. For example, a market participant may initiate a trade action (e.g., communicate a sell order, communicate a buy order, etc.) by directly selecting a trade action control (e.g., a button) corresponding to the desired trade action. Directly interacting with the trade application may be useful in that direct interaction eliminates (or nearly eliminates) the need for additional peripherals to execute a trade action (e.g., controlling a computer mouse to select a trade action control). As a result, a trade action may be executed more efficiently by the market participant.

Risk management refers to a process of identification, analysis and either acceptance or mitigation of uncertainty in trading, for example. Risk management can be based on a desired trade (e.g., potential for gain, potential for loss, investment objective, risk tolerance, etc.) and/or a trader seeking to make a trade (e.g., experienced, inexperienced, history of success, history of losses, trader rating/ranking, spending limit, etc.). If risk management is improper or lacking, traders, companies, and/or exchanges can suffer consequences.

A risk manager for a trading system helps ensure that traders operate according to parameters specified by risk administrators, who, in turn, are able to access information to maintain control. For example, a risk manager can include a position limit, an order type limit, an exchange limit, a cash limit, initial and variation margin limits, fill limit, live order cancellation, trading display, etc.

A risk manager can be used to define a trader's permissions and/or trading parameters, such as specifying order type(s) a trader can utilize, product(s) the trader can access, monetary limits, quantity limits, etc. One or more risk limits can be defined with threshold values configured to activate a response such as issue alerts, halt trades, etc., in response to encountering one of the limits. A response may be triggered when a measured value equals or exceeds a threshold value. Additional responses may be triggered in response to other user-defined events such as a market announcement, encountering a range or zone around one of the limits or other combinations of quantifiable events. In certain embodiments, the risk manager can provide an operating state of one or more exchanges, monitor trading activity, and highlight a risk level or status of active traders. The risk manager may further be configured to specify and manage the risk position and limits of multiple traders having different and/or configurable individual permissions and/or parameters.

For example, assume a first user has a maximum position limit of ten (10) for a given product and a second user has a maximum position limit of five (5) for another product. The first and second users execute orders via, for example, an electronic trading interface such as MD TRADER™ in X_TRADER™, provided by Trading Technologies International, Inc. of Chicago, Ill. (“Trading Technologies”). If the first user attempted to submit an order that could potentially increase the first user's aggregate long or short position beyond ten in the specified product, the risk manager would be reject the order. If the second user activated an automated trading algorithm that in response to a detected market condition or value attempted to submit an order for one, the risk manager would allow the order to proceed to the exchange as long as the second user's risk position remains under the maximum position limit of five (5).

The risk manager may further be configured to generate reports on one or more traders, risk limits, trading history and other metrics. In operation, the risk manager may be configured to provide a mechanism for human oversight of trading algorithms, enable more experienced traders to monitor less experienced traders, and provide risk managers greater control over a portfolio of trading algorithms.

Risk controls can be configured by a risk administrator within a trading provider or other organization. Risk controls can facilitate control over one or more aspects of a user's trading such as a) whether a user is enabled to submit orders, b) an amount of money the user is allowed to lose and continue to trade (including margin and additional margin values), c) products and product types that the user can trade, d) maximum size of a single order, e) maximum long or short position for a product, f) other administrator-defined condition.

Although the description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

I. Brief Description of Certain Embodiments

Certain embodiments provide a method including converting a profit and loss amount associated with a first trader to a first trader unit value, the first trader unit value associated with an increment. The example method includes normalizing the first trader unit value based on a risk scale to provide a first normalized unit value for the trader. The example method includes displaying the first normalized unit value for the trader in a ranking of one or more traders based on the normalized unit value for each trader. The example method includes comparing the first normalized unit value to a risk criterion. The example method includes enabling or impeding a trade action by the trader based on the comparing of the normalized unit value to the risk criterion.

Certain embodiments provide a system including a computing device. The example computing device is configured to convert a profit and loss amount associated with a first trader to a first trader unit value, the first trader unit value associated with an increment. The example computing device is configured to normalize the first trader unit value based on a risk scale to provide a first normalized unit value for the trader. The example computing device is configured to display the first normalized unit value for the trader in a ranking of one or more traders based on the normalized unit value for each trader. The example computing device is configured to compare the first normalized unit value to a risk criterion. The example computing device is configured to enable or impede a trade action by the trader based on the comparing of the normalized unit value to the risk criterion.

Certain embodiments provide a tangible computer-readable storage medium comprising instructions that, when executed, cause a computing device to, at least, convert a profit and loss amount associated with a first trader to a first trader unit value, the first trader unit value associated with an increment. The example computing device is configured to normalize the first trader unit value based on a risk scale to provide a first normalized unit value for the trader. The example computing device is configured to display the first normalized unit value for the trader in a ranking of one or more traders based on the normalized unit value for each trader. The example computing device is configured to compare the first normalized unit value to a risk criterion. The example computing device is configured to enable or impede a trade action by the trader based on the comparing of the normalized unit value to the risk criterion.

II. Example Electronic Trading System

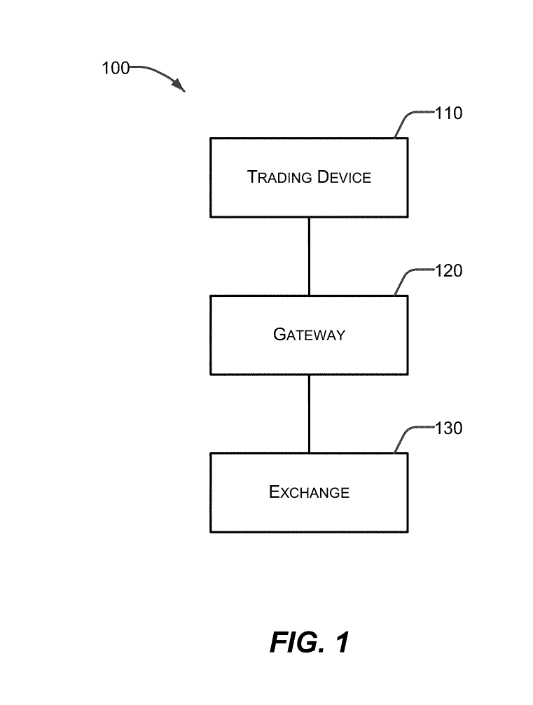

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market information including inside marker prices and the quantities associated with the prices, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. There may not be quantities at all tradeable price levels. As such, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies. As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

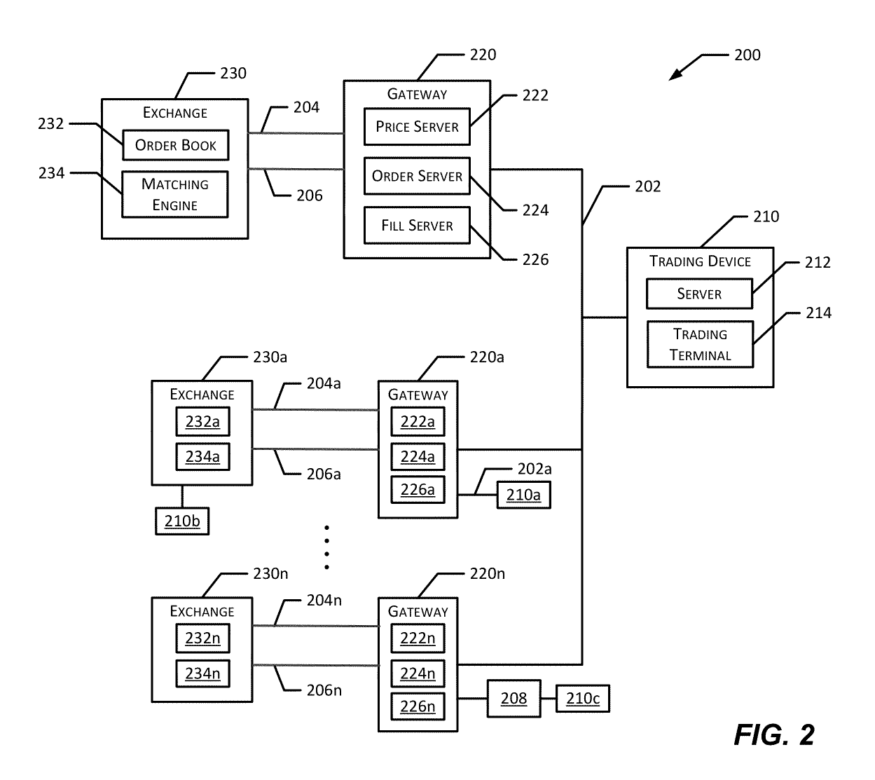

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

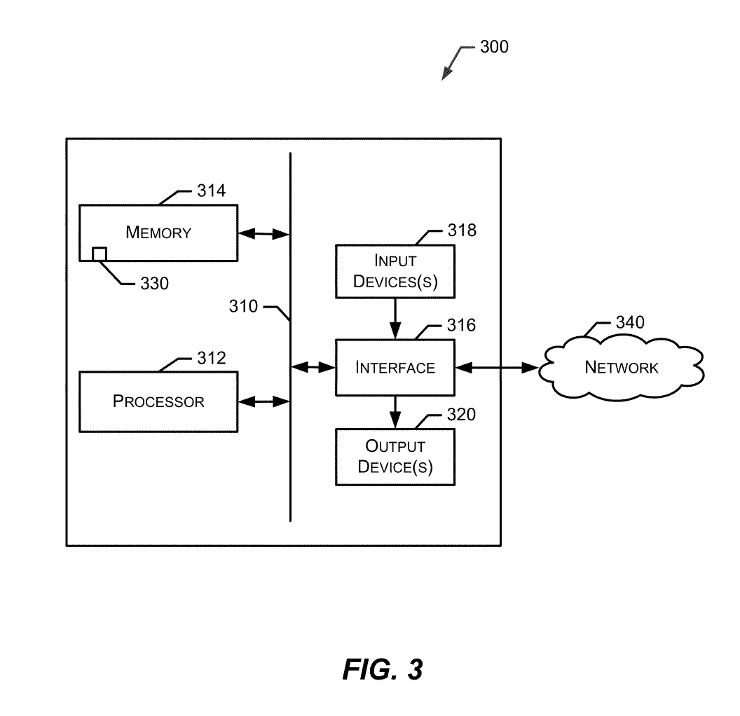

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. The input device 318 may be implemented by, for example, an audio sensor, a microphone, a keyboard, a button, a mouse, a touch screen, a track-pad, a trackball, iso-point and/or a voice recognition system. The output device 320 may be implemented by, for example, display devices (e.g., a light emitting diode (LED), an organic light emitting diode (OLED), a liquid crystal display, a cathode ray tube display (CRT), a touch screen, a tactile output device, etc.) a printer and/or speakers. As another example, the computing device 300 may not include an input device 318 and/or an output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Example Risk Checking Systems and Methods

Trade order and/or other messages can be transmitted between, for example, a trading device, an exchange, and a gateway according to a transmission protocol, such as the Financial Information eXchange (FIX) protocol. In certain examples, client applications and/or associated trading devices routing order messages perform risk checking Risk checking includes, but may not be limited to, a position check, an order quantity check, and a credit check, for example. A position check, for example, includes a comparison of a summation of order quantity, working quantities of existing orders and fills for a contract (e.g., Potential Position=Order Quantity+Working Quantities+Fills for Contract) to a user's position limit. To perform this position check calculation information regarding orders and fills is used at the computing device.

A credit check may include and/or account for the trader's current margin requirement along with a realized and an unrealized profit and loss (P&L). A margin requirement, as used in connection with futures trading, is the amount of money required to enter a position on a futures contract. The realized P&L is a gain or a loss resulting from opening and then closing positions related to one or more tradeable object. The unrealized P&L refers to a profit or loss that has occurred “on paper” but has not yet been “realized” because a position in a tradeable object has not yet been closed with an offsetting transaction. To perform an example credit check calculation, the available order and fill data for each user, or group of users, is accounted. The unrealized P&L component of the credit check also accounts for and estimates the prices at which any open positions might close.

In certain embodiments, credit checks may be performed without utilizing the margin requirement. For example, a server executing in a gateway can broadcast a Boolean value indicating whether or not a user/client application is over a limit instead of a calculated P&L value. In certain examples, the broadcasted Boolean value could be received at a trading device, utilized as a input into an automated trading algorithm and monitored by as risk manager and/or risk administrator. In certain examples, a risk manager can dynamically increase and/or decrease a risk associated with a user/client application. In certain examples, the risk manager can determine that a particular user/client application is not to be given a P&L risk check until it approaches an assigned limit. The limit can be set according to user/client application type, identification, market circumstances, etc. For additional information regarding trading limits, U.S. Pat. Nos. 7,752,117, 7,587,356, 7,565,315, and 7,707,098, commonly assigned to Trading Technologies, Inc., are each incorporated by reference herein in their entirety.

In certain examples, P&L risk checking can be enabled (e.g., by trading platform configuration, user profile, market condition, inside market, etc.). To perform one example credit risk check, a risk manager subscribes to messages (e.g., message feeds) for prices, orders, and fills relating to one or more trading devices and associated gateway(s).

A. Example Risk Administrator Device

Activating and authorizing an automated trading algorithm may involve a two-person authorization process. For example, a two-person authorization process may require the trader to acquire secondary approval from a person experienced in the design and/or execution of the trading algorithms in a live environment. In some example systems, such a designated approver is referred to as a risk manager or risk administrator. For example, the risk administrator may be a manager, administrator, experienced trader, or government official. In some examples, the risk administrator refers to a plurality of reviewing individuals and/or devices that form reviewing groups or teams.

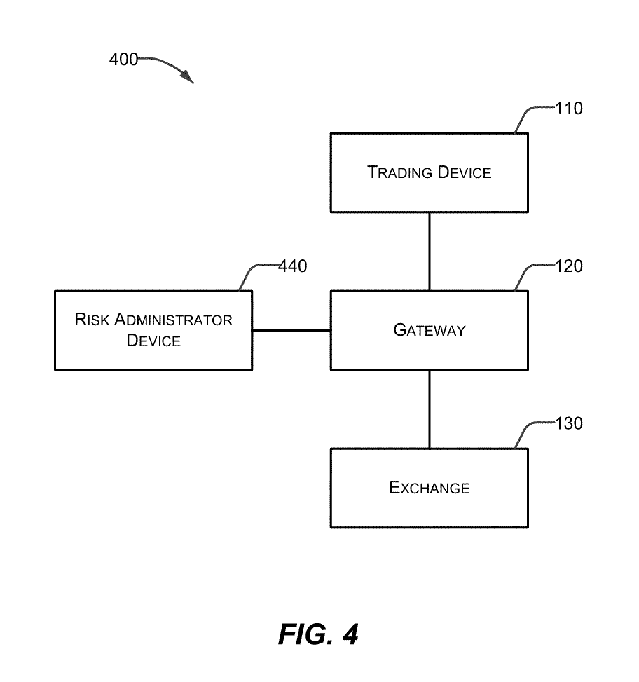

Referring to the example shown in FIG. 4, the system 400 includes a risk administrator device 440 in communication with trading device 110, gateway 120, and exchange 130. The risk administrator device 440 may enable a risk administrator to review and/or approve a trade and/or trading algorithm, for example. The risk administrator device 440 may be authorized to review and/or approve a trade and/or trading algorithm independent of a human risk manager. For example, the risk-administrator device 440 may be a computing device configured to, among other things, execute an authorization application that enables a human risk manager to review and/or approve a trading algorithm. In some examples, the authorization application is configured to review and/or approve the trading algorithm without intervention from the risk manager. For example, the authorization application may automatically review and/or approve the trading algorithm with no or minimal input from the risk manager. In some examples, the authorization application may be configured to analyze the trading algorithm and present an analysis of the trading algorithm (for example, through a user interface of the risk administrator device 440) to the human risk manager, which may then approve or reject the trading algorithm using a user interface of the risk administrator device 440 and/or of the authorization application. These examples are illustrative, and the disclosed example risk administrator device 440 may be implemented in additional or alternative manners.

The risk administrator device 440 is in communication with the trading device 110, the gateway 120, and/or the exchange 130. In some examples, the risk administrator device 440 need not be in communication with the gateway 120 and/or the exchange 130 and, instead, may be in communication only with the trading device 110. The example risk administrator device 440 may be configured to execute one or more trader applications (for example, X_TRADER®) and/or trading algorithm design tools (for example, ADL®). In some examples, the trader application(s) and/or trading algorithm design tool(s) may be configured to function as the authorization application.

In certain examples, the example risk administrator device 440 can normalize or otherwise rank a plurality of traders with respect to a risk threshold or other standard of risk. Based on an evaluation of relative risk in comparison to a threshold or standard, the risk administrator device 440 can assign a unit value to a trader representing a conversion of the trader's P&L amount to one or more units (and/or partial units). The unit value can be graphically depicted via the risk manager, for example.

B. Example Risk Normalization and Display Methods

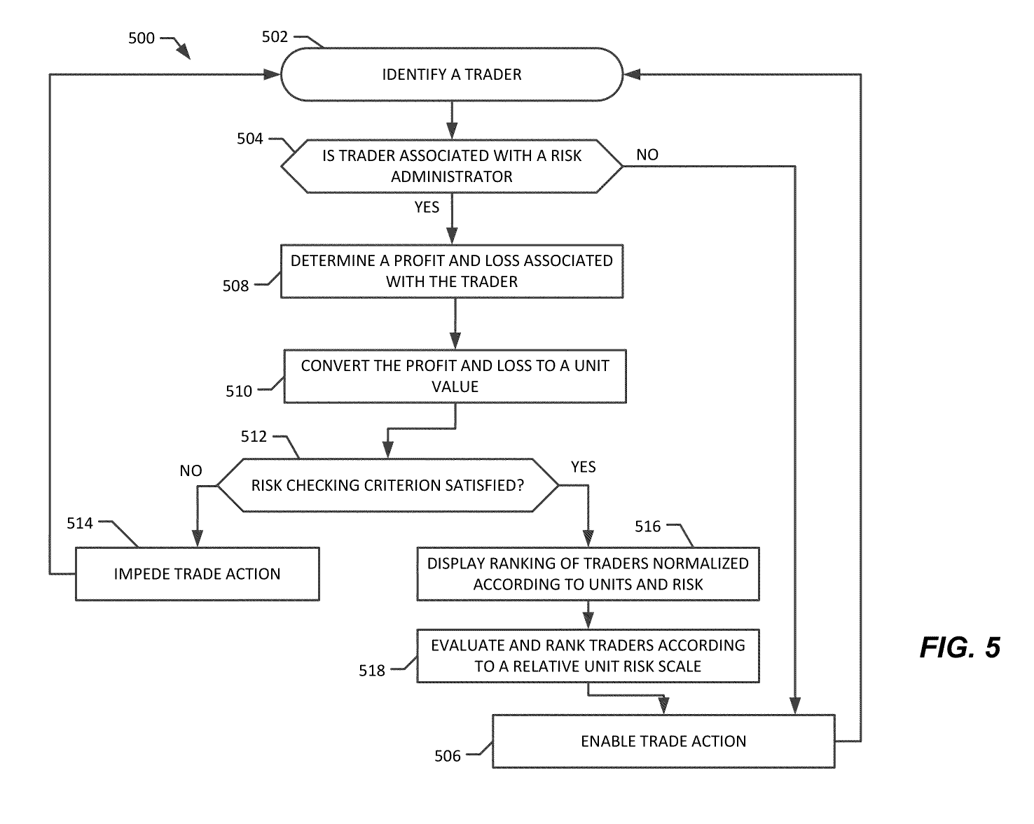

FIG. 5 illustrates a flow diagram of an example method 500 to quantify and visualize relative risk of one or more traders. For example, throughout the course of a trading day, the risk administrator for a group of traders often evaluates individual trader's performance based on their individual P&L levels. Each trader, however, may have a different trading limit and size with respect to other traders, for example. For example, a $1000 loss for a “big trader” A may not be as significant as a $1000 loss for a “small trader” B. Normalizing each user's P&L level with respect to, for example, trading limits such as maximum position, average open position, or another metric can help a risk administrator to better evaluate the status of his or her traders.

At block 502, the method 500 begins with the identification of a trader. For example, a trader name, trader identifier, trading device identifier, etc., is read and/or otherwise retrieved to identify a trader. An identified trader may have a unit conversion value associated with the trader indicating a relative risk associated with that trader, for example.

At block 504, the method 500 determines if a relationship exists between the identified trader and a risk administrator. If at block 504, the method 500 determines that the trader is not associated with the risk administrator (e.g., the risk administrator is not responsible for monitoring, evaluating, and/or otherwise regulating trading activity of the identified trader), then the trader's trading activity continues outside the regulation provided in the example method 500. For example, once a trader is determined to be unassociated with a risk administrator, the method proceeds to block 506 and a trade action associated with the trader is enabled. In certain embodiments, a trader may be prompted to select a risk administrator as a condition of trading. In other embodiments, the method 500 may search for or otherwise attempt to identify a risk administrator to associate with the trader.

If, at block 504, the trader is determined to be associated with the risk administrator, the method proceeds to block 508. At block 508, the method 500 determines or otherwise computes a profit and loss associated with the trader. For example, P&L information indicates that “Big Trader” A has a loss of $1000 and “Small Trader” B has a loss of $200. In certain examples, P&L can be based on a combination of realized and unrealized P&L. For example, the realized P&L is calculated by the gateway based on a fill quantity, a fill price, a total sell quantity, a total buy quantity, an average sell price, and an average buy price. For example, the unrealized P&L is calculated by the gateway based on a last traded price (or any other suitable theoretical exit price), an average open price, a total sell quantity, and a total buy quantity. A total P&L can be calculated based on the realized and unrealized P&L.

At block 510, the method 500 utilizes the computed P&L and converts it into a normalized unit value. The conversion to a normalized unit value allows the risk administrator to directly compare the different risk positions of different traders according to a common or standardized scale. For example, based on an assigned risk scale, “Big Trader” A has a unit value of $1000/unit, while “Small Trader” B has a unit value of $50/unit, indicating that the risk administrator has a greater tolerance for activity of “Big Trader” A than for “Small Trader” B. Based on the assigned risk scale, “Big Trader” A, with a loss of $1000, is assigned a risk unit value of “−1” ($1000 loss divided by a unit value of $1000/unit=−1). Accordingly, “Small Trader” B, with a loss of $200, is assigned a risk unit value of “−4” ($200 loss divided by a unit value of $50/unit=−4).

At block 512, the method 500 evaluates one or more risk checking criterion. For example, a unit risk value threshold may be set such that a trader with a unit value worse than a unit value of “−3” is to be pulled out of the market or otherwise restricted (e.g., temporarily, permanently, etc.) in trading. In certain examples, P&L risk checking also includes a risk check on maximum order quantity or other order quantity limit, maximum position, and P&L for one or more requested orders for a trader being reviewed. A worst-case-position calculation can be determined based on orders and fills for the given trader, for example. Orders submitted and the fills received to determine the user's worst-case-position. The worst-case-position can be used to evaluate a user's risk associated with a new trade action given the trader's unit risk value, for example.

If evaluated risk criterion(s) is not satisfied, then, at block 514, a trade action is impeded. For example, a trader's trade action can be blocked, the trader can be pulled from the market, the trader's trade action can be reduced, a visual warning can be displayed to the risk administrator, exchange, and/or trader, etc. For example, since “Small Trader” B has a unit risk value of “−4”, less than “−3”, a trade action input for execution by “Small Trader” B is impeded. Subsequently, the method 500 returns control to block 502 to await receipt of another trade action input in need of risk checking

If the one or more risk checking criterion are satisfied, the method 500 proceeds to block 516 where the individual traders are evaluated and ranked according to a relative unit risk scale. For example, using unit risk values allows the risk administrator to establish a set of unit risk values by which to rank and evaluate one or more traders (e.g., displayed in increments of 1.0, 0.5, etc.). In certain examples, a range of unit values and increments can be defined and/or otherwise customized by the risk administrator to correspond to how that administrator wants to evaluate risk.

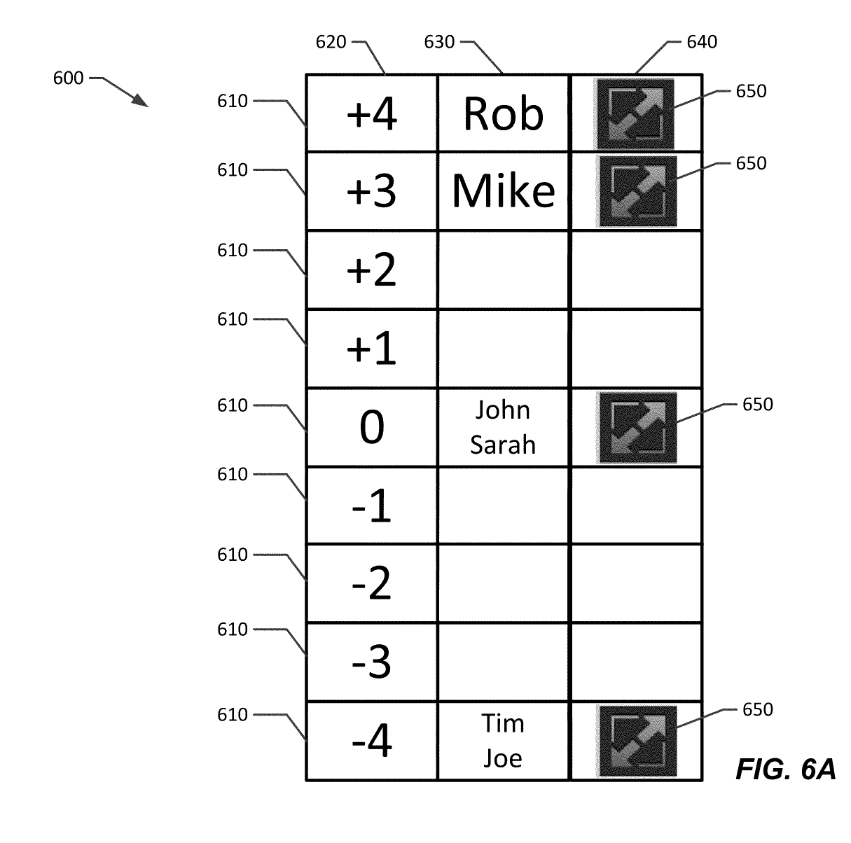

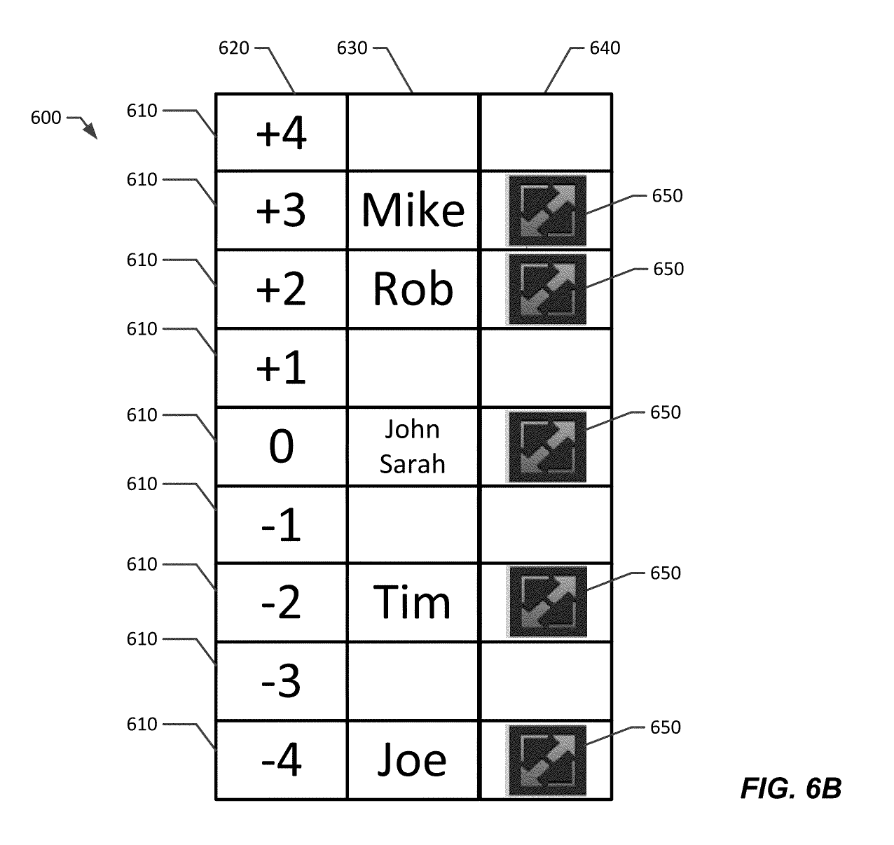

At block 518, the method 500 displays a ranking of traders in a normalized form according to units and risk. For example, a plurality of traders, each with an associated unit risk value, is ranked or organized in an order according to relative risk. A normalized ranking of traders can be represented as a ladder or incremental indicator of risk, for example. “Big Trader” A with a unit risk value of “−1” is ranked higher than “Small Trader” B with a unit risk value of “−4”, even though “Smaller Trader” B only lost $200, while “Big Trader” A has lost $1000. FIG. 6A, discussed further below, illustrates an example risk ladder 600 showing a plurality of traders ranked on the ladder 600, for example.

At block 506, the method 500 approves or otherwise allows execution of the requested trade action for at least the risk evaluated trader. For example, since “Big Trader” A has a unit risk value of “−1”, which is greater than unit risk threshold of “−3”, a trade action input for execution by “Big Trader” A is enabled. Subsequently, the method 500 returns control to block 502 to await receipt of another trade action input in need of risk checking

As the market changes and trading continues, the method 500 repeats to identify traders, update trader unit values, and enable or impede trade actions. FIGS. 6A-6B illustrate a change in trader position over time, resulting in a change in relative risk associated with each active trader.

FIGS. 6A-6B illustrate views of an example graphical user interface 600 providing a risk ladder display showing a plurality of active traders. The interface 600 can, for example, be displayed on a trading device, risk administrator device, risk management display, and/or other computing device. As depicted in the example of FIG. 6A, the risk ladder interface 600 may include a plurality of rows 610 and columns 620, 630, 640. Each of the plurality of rows, such as the row 610, represents a risk unit level. Within each row 610, a first column 620 identifies a relative or unit risk value for the trader. For example, a cell defined by the intersection of the row 610 and the column 620 may correspond a risk unit value of “+4”. A second column 630 represents those traders associated with the risk value. For example, a cell defined by the intersection of the row 610 and the column 630 identifies that the trader “Rob” currently carries a normalized risk position corresponding to the risk unit value of “+4”. A third column 640 provides further information for that trader. For example, a cell defined by the intersection of the row 610 and the column 640 includes a display element or control 650. The control 650 may, in response to selection by the user, expand to provide additional information regarding the risk unit value. In one example, the control 650 may provide the details, values and thresholds used to calculate the normalized risk position in terms of risk unit values. The columns 620, 630, 640 depicted in FIG. 6A are ordered and arranged for purposes of illustration only and may vary depending upon display space and/or other implementations constraints. In certain examples, the third column 640 may be eliminated and/or may be selectable based on a name or other identifier for a trader in the second column 630.

As shown in the example risk ladder interface 600, unit risk scale is expressed in the first column 620 based on increments of “1” from a low of “−4” to a high of “+4”. Increments can be based on a tick size (e.g., 0.5, 1.0, etc.), for example. In certain examples, trader risk is rounded up or down to a nearest (or worst) unit risk level to consolidate and organize the levels 620 in the ladder display 600. A plurality of traders including Rob, Mike, John, Sarah, Tim, and Joe 630 are evaluated and ranked on the ladder 600 according to a normalized unit value for each trader. Where more than one trader maps to a same unit value (e.g., John and Sarah or Tim and Joe), all traders at that value are listed together on the ladder 600.

As shown in the example ladder 600 of FIG. 6A, each active trader shown in the second column 630 has an associated icon in the third column 640 providing a link or other path to additional information or detail regarding the trader. Selecting the indicator in the third column 640 for one or more traders at that level 630 provides access to trader detail such as trader profit and loss, trader order information, trader history, etc. In certain examples, rather than a third column 640, further detail can be made accessible through selection of columns one 620 and/or two 630, gestures in columns one 620 and/or two 630, and/or other interaction with a level of the risk ladder interface 600.

In certain examples, traders listed in the second column 630 of the interface 600 are displayed via the risk ladder 600 to a risk administrator for approval when those traders have an order or other trade action to be executed. By selecting a trader in the second column 630, the risk administrator can enable or impede an associated trade action. Selection and action can be automated and/or manual, for example.

In certain examples, traders with unit values above a defined threshold do not require action by a risk administrator. For example, traders with a unit risk greater than or equal to “−3” have their trade actions automatically enabled unless overridden by the risk administrator. Traders with a unit risk of less than “−3” have their trade actions impeded unless overridden by the risk administrator, for example. Impeding can include flagging the trader to the risk administrator, pulling the trader out of the market, delaying the trader for a period of time, etc. In certain examples, multiple thresholds can be established to correspond to multiple administrator actions. For example, traders with a unit risk of greater than “−2” have their trade actions enabled; traders with a unit risk of less than “−3” have their trade actions denied; and traders with a unit risk of “−2” or “−3” are flagged for the risk administrator.

FIG. 6B illustrates a change in trader unit risk over time via the risk ladder interface 600. As demonstrated in the example of FIG. 6B, as trading continues, Rob's losses move him from “+4” on the risk ladder to “+2” on the risk ladder. Even with the decrease in unit value (an increase in risk associated with Rob), he remains above a trading risk threshold of “−3”, for example. Further, in the example of FIG. 6B, Tim's risk has decreased from a “−4” to a “−2”. Given a risk threshold of “−3”, Tim's trade action is now enabled, while Joe's trade action is still impeded, since his unit risk value remained a “−4”.

C. Example Risk Calculation Processor

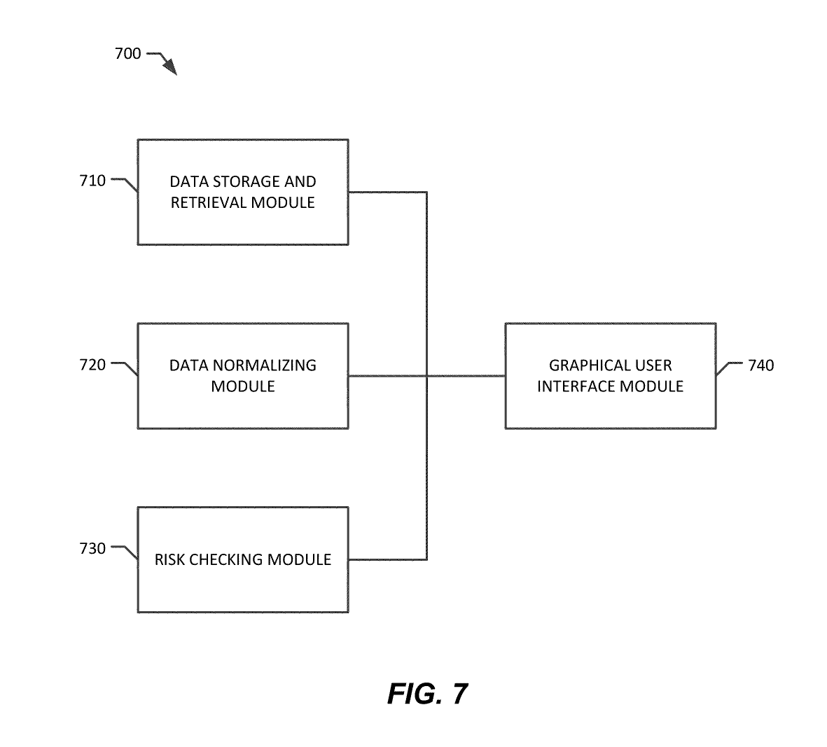

FIG. 7 illustrates a block diagram representative of an example risk calculation system 700 providing risk evaluation, monitoring, and display in a trading system. The risk calculator 700 can be implemented as part of or across one or more of a gateway, a strategy server, a trading device, and/or other computing device, for example. The example system 700 includes a data storage and retrieval module 710, a data normalizing module 720, a risk checking module 730, and a graphical user interface module 740.

In some examples, the system 700 may be implemented as part of software (or an application) associated with the trading device 110 of FIG. 1, the gateway 120 of FIG. 1 and/or the electronic exchange 130 of FIG. 1. In some examples, the system 700 may be implemented as computer implemented code or instructions operable independent of software associated with the trading device 110 of FIG. 1, the gateway 120 of FIG. 2 and/or the electronic exchange 130 of FIG. 1. In some examples, the features and functionality of the system 700 may be implemented in hardware operable in connection with the trading device 110 of FIG. 1, the gateway 120 of FIG. 1 and/or the electronic exchange 130 of FIG. 1.

In operation, the data storage and retrieval module 710 receives and/or retrieves information regarding active traders operating under a risk administrator's authority on an exchange. The module 710 may receive information from the exchange, an associated gateway, one or more trading devices, etc. The data normalizing module 720 processes the trader information to normalize the information in comparison to an increment or risk scale set by the administrator, exchange, trading company, etc. In conjunction with the normalized trader information, the risk checking module 730 evaluates each trader's unit risk against a threshold or trigger value to provide feedback to the risk administrator (e.g., a flag, a warning, a request for approval, etc.).

The data normalizing module 720 provides trader information and the risk checking module 730 provides relative risk information for each trader to the graphical interface module 740, which generates a graphical user interface, such as a risk ladder, to display to a risk administrator and/or other user. FIGS. 6A-6B, described above, provide examples of such a risk ladder interface displaying a plurality of traders according to associated unit risk values along a risk increment axis. In certain examples, via the graphical user interface ladder, the risk administrator can review, approve, deny, and/or otherwise monitor trading activity of the plurality of traders based on their relative risk.

Thus, certain embodiments provide improved risk evaluation in an electronic trading system. Certain embodiments provide tools for a risk administrator and/or other risk manager to visualize and manage varying risk among a plurality of traders. Certain embodiments help normalize relative risk according to a scale for the risk administrator to reduce manual computation and processing involved in risk checking calculation and evaluation among a group of traders.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method comprising:
converting, by a computing device, a profit and loss amount associated with a first trader to a first trader unit value, the first trader unit value associated with an increment;
normalizing, by the computing device, the first trader unit value based on a risk scale to provide a first normalized unit value for the trader;
displaying, by the computing device, the first normalized unit value for the trader in a ranking of one or more traders based on the normalized unit value for each trader;
comparing, by the computing device, the first normalized unit value to a risk criterion; and
enabling or impeding, by the computing device, a trade action by the trader based on the comparing of the normalized unit value to the risk criterion.

2. The method of claim 1, wherein the display comprises a ladder depicting the ranking of the one or more traders relative to a risk scale, the risk scale providing increments and decrements around a baseline of zero.

3. The method of claim 2, wherein the ladder comprises a column-based risk ladder including a first column displaying a normalized unit value for a trader, a second column displaying a trader identifier, and a third column providing access to trader detail.

4. The method of claim 3, wherein the trader detail comprises at least one of a) trader profit and loss or b) trader order information.

5. The method of claim 1, wherein the increment comprises a tick size associated with the unit value.

6. The method of claim 1, wherein the increment comprises at least one of 1.0 and 0.5.

7. The method of claim 1, wherein impeding the trade action comprises pulling the trader out of the market.

8. The method of claim 1, wherein impeding the trade action comprises flagging the trader to a risk administrator.

9. A system comprising:
a computing device configured to:
convert a profit and loss amount associated with a first trader to a first trader unit value, the first trader unit value associated with an increment;
normalize the first trader unit value based on a risk scale to provide a first normalized unit value for the trader;
display the first normalized unit value for the trader in a ranking of one or more traders based on the normalized unit value for each trader;
compare the first normalized unit value to a risk criterion; and
enable or impede a trade action by the trader based on the comparing of the normalized unit value to the risk criterion.

10. The system of claim 9, wherein the display comprises a ladder depicting the ranking of the one or more traders relative to a risk scale, the risk scale providing increments and decrements around a baseline of zero.

11. The system of claim 10, wherein the ladder comprises a column-based risk ladder including a first column displaying a normalized unit value for a trader, a second column displaying a trader identifier, and a third column providing access to trader detail.

12. The system of claim 11, wherein the trader detail comprises at least one of a) trader profit and loss or b) trader order information.

13. The system of claim 9, wherein the increment comprises a tick size associated with the unit value.

14. The system of claim 9, wherein the increment comprises at least one of 1.0 and 0.5.

15. The system of claim 9, wherein impeding the trade action comprises pulling the trader out of the market.

16. The system of claim 9, wherein impeding the trade action comprises flagging the trader to a risk administrator.

17. A tangible computer-readable storage medium comprising instructions that, when executed, cause a computing device to at least:
convert a profit and loss amount associated with a first trader to a first trader unit value, the first trader unit value associated with an increment;
normalize the first trader unit value based on a risk scale to provide a first normalized unit value for the trader;
display the first normalized unit value for the trader in a ranking of one or more traders based on the normalized unit value for each trader;
compare the first normalized unit value to a risk criterion; and
enable or impede a trade action by the trader based on the comparing of the normalized unit value to the risk criterion.

18. The computer-readable storage medium of claim 17, wherein the display comprises a ladder depicting the ranking of the one or more traders relative to a risk scale, the risk scale providing increments and decrements around a baseline of zero.

19. The computer-readable storage medium of claim 18, wherein the ladder comprises a column-based risk ladder including a first column displaying a normalized unit value for a trader, a second column displaying a trader identifier, and a third column providing access to trader detail.

20. The computer-readable storage medium of claim 19, wherein the trader detail comprises at least one of a) trader profit and loss or b) trader order information.
